(19) United States
(12) Patent Application Publication
(10) Pub. No.: US 2026/0243240 A1
(43) Pub. Date: Aug. 20, 2026

(54) ELECTRIC CYLINDER DEVICE

(71) Applicant: ADVICS CO., LTD., Kariya-shi, Aichi-ken (JP)

(72) Inventors: Yusuke SUGIURA, Kariya-shi, Aichi-ken (JP); Yuya HORIE, Kariya-shi, Aichi-ken (JP)

(73) Assignee: ADVICS CO., LTD., Kariya-shi, Aichi-ken (JP)

(21) Appl. No.: 19/164,502

(22) PCT Filed: Mar. 14, 2024
(86) PCT No.: PCT/JP2024/009936

§ 371 Date: Sep. 11, 2025

(30) Foreign Application Priority Data
Mar. 14, 2023 (JP) 2023-039469

(51) Int. Cl. F04B 17/03; B60T 13/74; F04B 49/06; F04B 49/20

(52) U.S. Cl. CPC F04B 17/03; F04B 49/065; F04B 49/20; B60T 13/745; F04B 2201/0201; F04B 2203/0201; F04B 2203/0209

(57) ABSTRACT

An electric cylinder device includes an electric cylinder and a control device. The electric cylinder includes an elastic body that applies, to a piston, a force to press the piston in a forward direction when the piston is located at an end-point position. The control device executes a process of moving the piston to the end-point position. In this process, the electric motor is driven such that the electric motor rotation speed becomes a target rotation speed to move the piston backward, and when a value of current flowing through the electric motor increases more than a determination value, it is determined that the piston reaches the end-point position, and electric motor driving is ended. The determination value is a value obtained by increasing the value of the current flowing through the electric motor when the electric motor rotation speed follows the target rotation speed.

### TECHNICAL FIELD

The present disclosure relates to an electric cylinder device.

### BACKGROUND ART

PTL 1 discloses an electric cylinder that moves a piston in a cylinder according to driving of an electric motor. In this electric cylinder, a position where the piston is advanced by a predetermined amount after the piston is retracted to an end-point position is set as an origin position serving as a base point for generating a hydraulic pressure. The end-point position is detected by setting a rotation angle on a most backward direction side as a rotation angle corresponding to the end-point position when a time displacement of rotation angle of the electric motor converges due to the piston coming into contact with an end in a backward direction.

### CITATION LIST

### Patent Literature

PTL 1: JP2014-19246A.

### SUMMARY

### Technical Problem

When driving of the electric motor is continued in a state where movement of the piston in the backward direction is restricted by the piston coming into contact with the end in the backward direction in the electric cylinder, a rotational torque generated by the electric motor may become excessively large.

When the end-point position is detected by coming into contact with the piston as in PTL 1, a load applied to the electric cylinder increases, and thus the durability of the components constituting the electric cylinder may decrease.

### Solution to Problem

An electric cylinder device for solving the above problem is an electric cylinder device that supplies a hydraulic fluid to a supply target, and the electric cylinder device includes: a reservoir tank configured to store a hydraulic fluid; an electric cylinder configured to supply the hydraulic fluid to the supply target by moving a piston in a cylinder according to driving of an electric motor; and a control device configured to control the electric motor. The electric cylinder includes a hydraulic chamber defined in the cylinder by the cylinder and the piston, an input port via which the reservoir tank and the hydraulic chamber communicate with each other, and an output port configured to discharge the hydraulic fluid in the hydraulic chamber toward the supply target. A direction in which a volume of the hydraulic chamber is reduced among moving directions of the piston is defined as a forward direction, and a direction opposite to the forward direction among the moving directions is defined as a backward direction. The control device drives the electric motor by using, when moving the piston, a position where the piston is moved to an end in the backward direction as an end-point position and an origin position, which is a position obtained by moving the piston from the end-point position in the forward direction by a prescribed movement amount. The electric cylinder includes an elastic body configured to apply, to the piston, a force to press the piston in the forward direction when the piston is located at the end-point position, the electric cylinder is configured such that a hydraulic pressure of the hydraulic chamber is increased by opening the input port when the piston is located at the origin position, and closing the input port by the piston when the piston moves in the forward direction from the origin position, the control device executes an end-point movement process of moving the piston to the end-point position to set a relative position of the piston with respect to the input port. In the end-point movement process, the control device drives the electric motor such that a rotation speed of the electric motor becomes a target rotation speed to move the piston in the backward direction, and when a current value of a current flowing through the electric motor increases more than a determination value, the control device determines that the piston reaches the end-point position and ends the driving of the electric motor, and the determination value is a value obtained by increasing, by an increase amount, the current value of the current flowing through the electric motor when the rotation speed of the electric motor follows the target rotation speed with the current value as a reference.

According to the above configuration, when the end-point movement process is executed, the piston and the elastic body come into contact with each other when the electric motor is driven to move the piston in the backward direction such that the rotation speed follows the target rotation speed. When the piston continues to move in the backward direction even after the piston and the elastic body come into contact with each other, a torque gradually increases as the elastic body elastically deforms after the piston and the elastic body come into contact with each other. Therefore, when the piston approaches the end-point position, a torque generated by the electric motor, that is, the current value of the current flowing through the electric motor gradually increases. Therefore, in the above configuration, the determination value for determining that the piston reaches the end-point position is set with reference to the current value of the current flowing through the electric motor when the rotation speed of the electric motor follows the target rotation speed. By setting a value obtained by increasing, by the increase amount, a reference current value as the determination value, the current value is unlikely to become excessively large before the piston is completely moved in the backward direction. Accordingly, it is possible to prevent an increase in a load applied to the electric cylinder when the piston is moved to the end-point position.

### BRIEF DESCRIPTION OF DRAWINGS

FIG. 1 is a schematic view showing a braking device to which an embodiment of an electric cylinder device is applied.

FIG. 2 is a cross-sectional view schematically showing a structure of an electric cylinder provided in the electric cylinder device in FIG. 1.

FIG. 3 is a cross-sectional view schematically showing the structure of the electric cylinder provided in the electric cylinder device in FIG. 1.

FIG. 4 is a flowchart showing a flow of a process executed by a control device provided in the electric cylinder device in FIG. 1.

FIGS. 5A to 5C are a timing chart showing transition of a current value when a piston moves to an end-point position in the electric cylinder device in FIG. 1.

FIG. 6 is a cross-sectional view schematically showing the structure of the electric cylinder provided in the electric cylinder device in FIG. 1.

### DESCRIPTION OF EMBODIMENTS

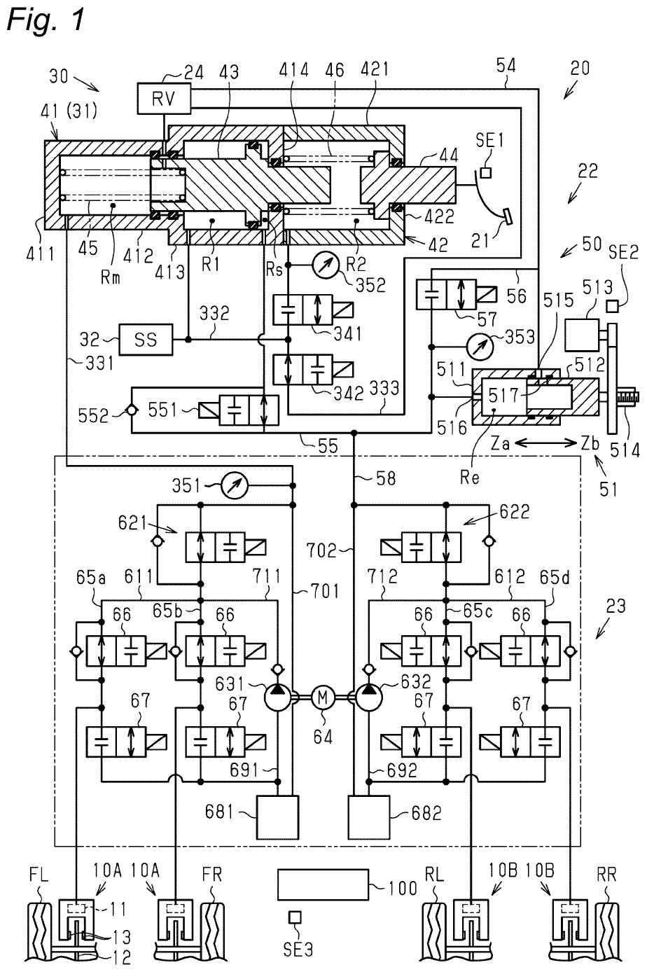

Hereinafter, an embodiment of an electric cylinder device will be described with reference to FIGS. 1 to 6.

FIG. 1 shows a braking device 20 of a vehicle as an example to which an electric cylinder device is applied. The braking device 20 includes braking units capable of applying a braking force to wheels of the vehicle. The braking device 20 includes a control device 100 capable of controlling the braking units. An example of the braking device 20 includes a first braking unit 50 and a second braking unit 23 as the braking units. The first braking unit 50 includes an electric cylinder 51. The electric cylinder device includes the electric cylinder 51 and the control device 100. The electric cylinder device includes a reservoir tank 24.

FIG. 1 shows front wheels FL and FR and rear wheels RL and RR as wheels of the vehicle. The vehicle includes a braking operation member 21. The braking operation member 21 can be operated by a driver of the vehicle. An example of the braking operation member 21 is a brake pedal.

The control device 100 is an example of a processing circuit included in the vehicle. The vehicle may include, not limited to the control device 100, other processing circuits. A part of the functions implemented by the control device 100 may be implemented by another processing circuit. The processing circuits included in the vehicle may be connected to each other so as to be able to transmit and receive information to and from each other. For example, a configuration can be adopted in which the processing circuits are connected to an in-vehicle network included in the vehicle. The processing circuits connected to the in-vehicle network can communicate with each other via the in-vehicle network. For example, a detection system such as various sensors included in the vehicle may be connected to the in-vehicle network.

### Braking Device

The braking device 20 includes braking mechanisms corresponding to the wheels FL, FR, RL, and RR, respectively. A friction braking force can be applied to each of the wheels FL, FR, RL, and RR by the corresponding braking mechanism. The friction braking force applied to the wheels FL, FR, RL, RR by each braking mechanism can be adjusted by the braking device 20. FIG. 1 shows, as braking mechanisms, front-wheel braking mechanisms 10A corresponding to the front wheels FL and FR of the wheels and rear-wheel braking mechanisms 10B corresponding to the rear wheels RL and RR of the wheels.

An example of the braking device 20 is a hydraulic braking device. For example, the braking device 20 includes the reservoir tank 24 that stores brake fluid and a hydraulic pressure generation device 22. An example of the hydraulic pressure generation device 22 is a so-called brake-by-wire hydraulic pressure generation device. The hydraulic pressure generation device 22 is able to generate a hydraulic pressure according to an operation amount of the braking operation member 21. The hydraulic pressure generation device 22 includes a master device 30 and the first braking unit 50. The master device 30 can supply the brake fluid to the second braking unit 23. The first braking unit 50 can supply the brake fluid to the master device 30 and the second braking unit 23.

### Braking Mechanism

Each of the front-wheel braking mechanisms 10A and each of the rear-wheel braking mechanisms 10B will be described. The front-wheel braking mechanism 10A includes a wheel cylinder 11 to which the brake fluid is supplied, a rotary plate 12 that rotates integrally with the wheels, and a friction material 13 that moves relative to the rotary plate 12 in a plate thickness direction of the rotary plate 12. The front-wheel braking mechanism 10A is configured to strongly press the friction material 13 against the rotary plate 12 as a WC pressure Pwc which is a hydraulic pressure in the wheel cylinder 11 increases. Similarly to the front-wheel braking mechanism 10A, the rear-wheel braking mechanism 10B includes the wheel cylinder 11, the rotary plate 12, and the friction material 13. According to the braking mechanism, as the WC pressure Pwc increases, the friction braking force applied to the wheels FL, FR, RL, and RR increases.

### Master Device

An example of the master device 30 includes a master cylinder 31, a stroke simulator 32, a plurality of flow paths 331, 332 and 333 connected to the master cylinder 31, and a plurality of control valves 341 and 342 that control flow of the brake fluid. The stroke simulator 32 can generate a reaction force corresponding to the operation amount of the braking operation member 21.

The master cylinder 31 includes a main cylinder 41 and a cover cylinder 42. The master cylinder 31 includes a master piston 43 and an input piston 44. The master cylinder 31 includes a master spring 45 that applies a force to press the master piston 43, and an input spring 46 that applies a force to press the input piston 44. The master piston 43 and the input piston 44 can move relative to the main cylinder 41 and the cover cylinder 42.

An example of the master cylinder 31 will be described in more detail.

The main cylinder 41 of the master cylinder 31 has a plate-shaped bottom wall 411 and a first peripheral wall 412 extending from the bottom wall 411 along an axis of the bottom wall 411. The main cylinder 41 further includes a second peripheral wall 413 extending from a rear end of the first peripheral wall 412 along an axis of the first peripheral wall 412, and a first annular wall 414 extending from a rear end of the second peripheral wall 413 toward an axis of the second peripheral wall 413. Each of the first peripheral wall 412 and the second peripheral wall 413 has a tubular shape. A hole into which a rear end portion of the master piston 43 to be described later is inserted is formed in the first annular wall 414. An inner diameter of the first peripheral wall 412 is smaller than an inner diameter of the second peripheral wall 413.

A master chamber Rm is defined in the main cylinder 41 by the bottom wall 411, the first peripheral wall 412, and the master piston 43. Hereinafter, in the master cylinder 31, among moving directions of the master piston 43, a left side in FIG. 1, that is, a direction for reducing a volume of the master chamber Rm is referred to as a “front side”. On the other hand, a direction opposite to the front side among the moving directions of the master piston 43 is referred to as a “rear side”. The rear side is also a direction for increasing the volume of the master chamber Rm.

In the main cylinder 41, a first fluid chamber R1 is defined by the second peripheral wall 413 and the master piston 43, and a servo chamber Rs is defined by the second peripheral wall 413, the first annular wall 414, and the master piston 43. The master chamber Rm is formed at a position near a front end of the master cylinder 31. The first fluid chamber R1 is formed behind the master chamber Rm. The servo chamber Rs is formed behind the first fluid chamber R1. Inside the main cylinder 41, the master chamber Rm, the first fluid chamber R1, and the servo chamber Rs are not connected to each other. A cross-sectional area of the master chamber Rm is equal to a cross-sectional area of the servo chamber Rs. Here, the cross-sectional area of the servo chamber Rs is a cross-sectional area of the servo chamber Rs in a state where the master piston 43 is accommodated.

The cover cylinder 42 of the master cylinder 31 includes a tubular third peripheral wall 421 and a second annular wall 422 extending from a rear end of the third peripheral wall 421 toward an axis of the third peripheral wall 421. The third peripheral wall 421 is attached to the first annular wall 414 such that the axis thereof coincides with the axis of the second peripheral wall 413 of the main cylinder 41. The second annular wall 422 is provided with a hole into which a rear end portion of the input piston 44 to be described later is inserted.

In the cover cylinder 42, a second fluid chamber R2 is defined by the third peripheral wall 421, the second annular wall 422, and the first annular wall 414 of the main cylinder 41. In the master cylinder 31, the second fluid chamber R2 is formed behind the servo chamber Rs.

The master piston 43 is accommodated in the master cylinder 31 in surface contact with an inner peripheral surface of the first peripheral wall 412, an inner peripheral surface of the second peripheral wall 413, and an inner peripheral surface of the first annular wall 414 of the main cylinder 41. Therefore, when the master piston 43 moves in an axial direction, the master piston 43 slides on the inner peripheral surface of the first peripheral wall 412, the inner peripheral surface of the second peripheral wall 413, and the inner peripheral surface of the first annular wall 414. The rear end portion of the master piston 43 protrudes further rearward relative to the first annular wall 414 and is located in the second fluid chamber R2. An area of the rear end portion of the master piston 43 is equal to the cross-sectional area of the first fluid chamber R1. Here, the area of the rear end portion of the master piston 43 is an area that receives a force in the axial direction by a hydraulic pressure in the second fluid chamber R2. Here, the cross-sectional area of the first fluid chamber R1 is a cross-sectional area of the first fluid chamber R1 in a state where the master piston 43 is accommodated.

The input piston 44 is accommodated in the master cylinder 31 in surface contact with an inner peripheral surface of the second annular wall 422 of the cover cylinder 42. Therefore, when the input piston 44 moves in the axial direction, the input piston 44 slides on the inner peripheral surface of the second annular wall 422. The rear end portion of f the input piston 44 protrudes further rearward relative to the second annular wall 422. The braking operation member 21 is coupled to the rear end portion of the input piston 44. Therefore, the input piston 44 moves in a direction of approaching the master piston 43 according to the operation amount of the braking operation member 21. Further, in the second fluid chamber R2, a gap is formed between the input piston 44 and the master piston 43.

The master spring 45 is disposed in the master chamber Rm of the main cylinder 41. The master spring 45 applies, to the master piston 43, a force to press the master piston 43 rearward. Therefore, the master spring 45 is elastically compressed when the master piston 43 moves forward.

The input spring 46 is disposed in the second fluid chamber R2 of the cover cylinder 42. The input spring 46 applies, to the input piston 44, a force to press the input piston 44 rearward. Therefore, the input spring 46 is elastically compressed when the input piston 44 moves forward.

In the master cylinder 31, the master chamber Rm is connected to the reservoir tank 24. Specifically, a portion near a rear end of the master chamber Rm is connected to the reservoir tank 24 via a port formed in the first peripheral wall 412 of the main cylinder 41. Therefore, when the master piston 43 moves forward from an initial position shown in FIG. 1, the master chamber Rm and the reservoir tank 24 are not connected. As a result, a hydraulic pressure in the master chamber Rm increases as the master piston 43 moves forward. For example, when a hydraulic pressure in the servo chamber Rs increases, the master piston 43 moves forward by the hydraulic pressure in the servo chamber Rs. Accordingly, the hydraulic pressure in the master chamber Rm increases.

A first flow path 331 connects the master chamber Rm and the second braking unit 23. That is, the first flow path 331 is a flow path that connects some of the plurality of wheel cylinders 11 and the master chamber Rm. Specifically, the first flow path 331 connects the master chamber Rm and the wheel cylinders 11 for the front wheels FL and FR. A second flow path 332 connects the first fluid chamber R1 and the second fluid chamber R2. A third flow path 333 connects the reservoir tank 24 and the second flow path 332.

A first control valve 341 is a normally closed electromagnetic valve. A second control valve 342 is a normally open electromagnetic valve. The first control valve 341 is disposed between the second fluid chamber R2 and a connection point with the third flow path 333 in the second flow path 332. The second control valve 342 is provided in the third flow path 333. When the control device 100 of the braking device 20 is operating, the first control valve 341 is opened and the second control valve 342 is closed.

The stroke simulator 32 is disposed between the first fluid chamber R1 and the first control valve 341 in the second flow path 332. For example, the stroke simulator 32 includes therein a piston to which a force for pressing the piston from a back surface is applied by a spring. In this case, when the brake fluid flows into the stroke simulator 32 from the second flow path 332 and the piston inside the stroke simulator 32 is displaced against the force of the spring, the stroke simulator 32 generates a pressure in the brake fluid in accordance with the displacement of the piston. Illustration of the piston is omitted. Specifically, when the input piston 44 is moved forward by the operation of the braking operation member 21 in a state where the first control valve 341 is opened and the second control valve 342 is closed, a volume of the second fluid chamber R2 decreases by a volume of the input piston 44 entering the second fluid chamber R2. Therefore, the brake fluid flowing out from the second fluid chamber R2 to the second flow path 332 flows into the stroke simulator 32. As a result, the stroke simulator 32 generates the same pressure in the second fluid chamber R2 and the first fluid chamber R1 that are connected by the second flow path 332. When the area of the rear end portion of the master piston 43 protruding into the second fluid chamber R2 is equal to the cross-sectional area of the first fluid chamber R1, in a state where the same pressure is generated in the second fluid chamber R2 and the first fluid chamber R1, the master piston 43 is not moved in the axial direction by this pressure.

### First Braking Unit

The first braking unit 50 includes the electric cylinder 51 including a first electric motor 513 as a power source. The first braking unit 50 can adjust the WC pressure Pwc by the electric cylinder 51 that operates according to a driving amount of the first electric motor 513. That is, the first braking unit 50 can generate a braking force for the wheels FL, FR, RL, and RR of the vehicle.

An example of the first braking unit 50 will be described.

The first braking unit 50 includes the electric cylinder 51, a hydraulic pressure adjustment valve 551, and a check valve 552.

The first braking unit 50 includes a fourth flow path 54 that connects the electric cylinder 51 and the reservoir tank 24. The first braking unit 50 includes a sixth flow path 58 that connects the second braking unit 23 and the electric cylinder 51. The first braking unit 50 includes a fifth flow path 55 that connects the servo chamber Rs of the master cylinder 31 and the sixth flow path 58.

The hydraulic pressure adjustment valve 551 is provided in the fifth flow path 55. The hydraulic pressure adjustment valve 551 is an electromagnetic valve that adjusts a differential pressure between a portion of the fifth flow path 55 closer to the servo chamber Rs than the hydraulic pressure adjustment valve 551 and a portion of the fifth flow path 55 closer to the electric cylinder 51 than the hydraulic pressure adjustment valve 551. That is, the hydraulic pressure adjustment valve 551 can adjust an amount of the brake fluid supplied to the servo chamber Rs.

The check valve 552 is provided in parallel with the hydraulic pressure adjustment valve 551 in the fifth flow path 55. The check valve 552 allows the brake fluid to flow through the check valve 552 from the servo chamber Rs toward the electric cylinder 51. On the other hand, the check valve 552 restricts the flow of the brake fluid passing through the check valve 552 from the electric cylinder 51 toward the servo chamber Rs.

### Electric Cylinder

The electric cylinder 51 provided in the first braking unit 50 is provided between the fourth flow path 54 and the sixth flow path 58. The fourth flow path 54 is connected to an input port 515 of the electric cylinder 51. The sixth flow path 58 is connected to an output port 516 of the electric cylinder 51. The input port 515 and the output port 516 will be described later.

A configuration of the electric cylinder 51 will be described with reference to FIGS. 1, 2, and 3.

The electric cylinder 51 includes a cylinder 511, a piston 512, the first electric motor 513, and a conversion mechanism 514. The piston 512 is slidably provided in the cylinder 511. The first electric motor 513 is a power source of the electric cylinder 51. The conversion mechanism 514 converts a rotational motion of an output shaft of the first electric motor 513 into a linear motion of the piston 512.

Inside the cylinder 511, a hydraulic chamber Re into which the brake fluid is introduced is defined by a peripheral wall of the cylinder 511 and the piston 512. A position of the piston 512 inside the cylinder 511 can be changed by driving of the first electric motor 513. Hereinafter, a direction for reducing a volume of the hydraulic chamber Re among the moving directions of the piston 512 is referred to as a “forward direction Za”. A direction opposite to the forward direction Za among the moving directions of the piston 512 is referred to as a “backward direction Zb”. The backward direction Zb is also a direction for increasing the volume of the hydraulic chamber Re among the moving directions of the piston 512.

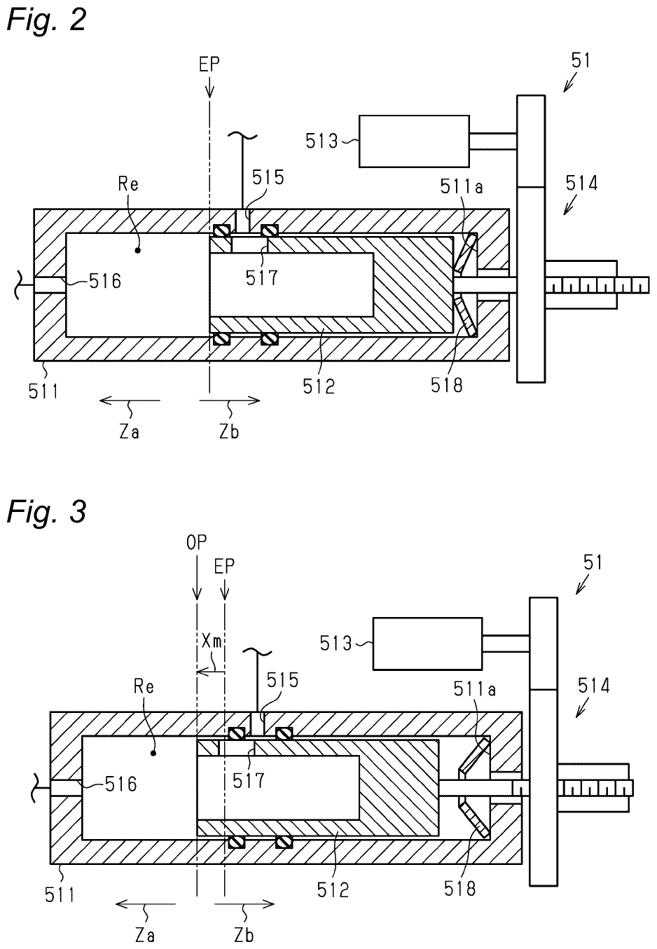

When the piston 512 is moved, the control device 100 uses an end-point position EP and an origin position OP. FIG. 2 shows the electric cylinder 51 in a state where the piston 512 is located at the end-point position EP. The end-point position EP is a position where the piston 512 is moved to an end in the backward direction Zb. FIG. 3 shows the electric cylinder 51 in a state where the piston 512 is located at the origin position OP. The origin position OP is a position obtained by moving the piston 512 from the end-point position EP in the forward direction Za by a specified movement amount Xm. The origin position OP is a base point when the hydraulic pressure is generated by the electric cylinder 51.

As shown in FIGS. 2 and 3, the electric cylinder 51 includes an elastic body 518. The elastic body 518 applies, to the piston 512, a force to press the piston 512 in the forward direction Za when the piston 512 is located at the end-point position EP. The elastic body 518 is disposed to restrict the piston 512 from moving in the backward direction Zb by the contact of the piston 512 with the elastic body 518. For example, as shown in FIGS. 2 and 3, the elastic body 518 is disposed to be in contact with a rear inner wall 511a of the cylinder 511. For example, as shown in FIG. 2, the elastic body 518 is disposed to be in contact with an end surface of the piston 512 in the backward direction Zb located at the end-point position EP.

An example of the elastic body 518 is a disc spring. As the elastic body 518, a leaf spring, a coil spring, or the like can also be adopted. As the elastic body 518, an elastic member formed of an elastic material such as elastomer or rubber can also be adopted. In FIGS. 2, 3, and 6, a disc spring deformable to a flat plate shape is shown as the elastic body 518.

When the piston 512 further moves in the backward direction Zb after the piston 512 comes into contact with the elastic body 518 by the movement of the piston 512 in the backward direction Zb, the elastic body 518 is elastically deformed. When the piston 512 further moves in the backward direction Zb while the elastic body 518 is elastically deformed, the limit of elastic deformation is eventually reached. The end-point position EP is set as a position between a position of the piston 512 at which the elastic body 518 starts to elastically deform and a position of the piston 512 at which the elastic body 518 deforms to the limit. The elastic body 518 shown in FIG. 2 is in a state of starting to elastically deform as an example.

The input port 515 and the output port 516 are formed in the peripheral wall of the cylinder 511 as ports connecting the hydraulic chamber Re and the outside. A through hole 517 is formed in the piston 512. The through hole 517 is formed at a position where the input port 515 and the hydraulic chamber Re can communicate with each other when the piston 512 is located at the end-point position EP. Accordingly, when the piston 512 is located at the end-point position EP, the hydraulic chamber Re of the cylinder 511 and the fourth flow path 54 communicate with each other via the input port 515 and the through hole 517. That is, the hydraulic chamber Re of the cylinder 511 and the reservoir tank 24 communicate with each other via the input port 515 and the through hole 517. As shown in FIGS. 2 and 3, the input port 515 is open when the piston 512 is located between the end-point position EP and the origin position OP. The electric cylinder 51 is configured such that the input port 515 is closed by the piston 512 when the piston 512 moves from the origin position OP in the forward direction Za. Thus, when the piston 512 further moves in the forward direction Za after the input port 515 is closed by the piston 512, a hydraulic pressure in the hydraulic chamber Re increases.

The output port 516 of the cylinder 511 is connected to the second braking unit 23 and the fifth flow path 55 via the sixth flow path 58. The output port 516 is always open regardless of the position of the piston 512. Therefore, in a case where the input port 515 is closed by the piston 512, when the piston 512 moves in the forward direction Za, the brake fluid in the hydraulic chamber Re is discharged from the output port 516 to the outside of the cylinder 511.

As shown in FIGS. 1 to 3, the electric cylinder 51 provided in the braking device 20 does not include a spring that applies a force to press the piston 512 in the backward direction Zb. The electric cylinder 51 may include a spring that applies a force to press the piston 512 in the backward direction Zb.

As shown in FIG. 1, the first braking unit 50 includes a release flow path 56 and a release valve 57 disposed in the release flow path 56. The release flow path 56 is a flow path that connects the reservoir tank 24 and the wheel cylinder 11 so as to bypass the electric cylinder 51. A first end portion of the release flow path 56 is connected to the fourth flow path 54, and a second end portion of the release flow path 56 is connected to the sixth flow path 58. Specifically, the release flow path 56 connects between the reservoir tank 24 and the input port 515 in the fourth flow path 54 and connects between the output port 516 and the second braking unit 23 in the sixth flow path 58. The release valve 57 is a normally closed electromagnetic valve. Therefore, when control of opening the release valve 57 is not performed, the release flow path 56 is closed.

### Second Braking Unit

As shown in FIG. 1, the second braking unit 23 includes a second electric motor 64 as a power source. The second braking unit 23 can generate a braking force for the wheels FL, FR, RL, and RR of the vehicle according to a driving amount of the second electric motor 64. The second braking unit 23 is interposed between the first braking unit 50 and the wheel cylinder 11.

An example of the second braking unit 23 will be described.

The second braking unit 23 is a braking actuator capable of individually adjusting the WC pressure Pwc of each of the wheels FL, FR, RL, and RR. The second braking unit 23 includes pumps 631 and 632 that discharge the brake fluid. The pumps 631 and 632 are driven by the second electric motor 64.

The second braking unit 23 can increase the WC pressure Pwc without increasing the hydraulic pressure of the brake fluid regulated by the first braking unit 50. The braking device 20 has a redundant configuration in which the first braking unit 50 is on an upstream side and the second braking unit 23 is on a downstream side.

The second braking unit 23 includes two hydraulic circuits 611 and 612 of two systems. Two wheel cylinders 11 for the front wheels FL and FR are connected to a first hydraulic circuit 611. Two wheel cylinders 11 for the rear wheels RL and RR are connected to a second hydraulic circuit 612.

The first hydraulic circuit 611 is connected to the reservoir tank 24 via the first flow path 331 and the master chamber Rm. In the first hydraulic circuit 611, a first differential pressure control valve 621, which is a normally open linear electromagnetic valve, is provided in a fluid path connecting a connection point with the first flow path 331 and the wheel cylinder 11. A check valve is provided in parallel with the first differential pressure control valve 621 in the fluid path. The check valve allows the brake fluid to flow through the check valve in a direction from the first flow path 331 toward the wheel cylinder 11. On the other hand, the check valve restricts the flow of the brake fluid passing through the check valve in a direction from the wheel cylinder 11 to the first flow path 331.

The second hydraulic circuit 612 is connected to the reservoir tank 24 via the fourth flow path 54, the electric cylinder 51, and the sixth flow path 58. In the second hydraulic circuit 612, a second differential pressure control valve 622, which is a normally open linear electromagnetic valve, is provided in a fluid path connecting a connection point with the sixth flow path 58 and the wheel cylinder 11. A check valve is provided in parallel with the second differential pressure control valve 622 in the fluid path. The check valve allows the brake fluid to flow through the check valve in a direction from the sixth flow path 58 toward the wheel cylinder 11. On the other hand, the check valve restricts the flow of the brake fluid passing through the check valve in a direction from the wheel cylinder 11 to the sixth flow path 58.

The pump 631 is provided in the first hydraulic circuit 611. The pump supplies the brake fluid to a fluid path connecting the first differential pressure control valve 621 and the wheel cylinder 11. A check valve is arranged in series between the pump 631 and the fluid path. The check valve allows the brake fluid to flow in a direction in which the brake fluid is discharged from the pump 631. On the other hand, the check valve restricts the brake fluid from flowing in a direction in which the brake fluid discharged from the pump 631 returns to the pump 631.

The pump 632 is provided in the second hydraulic circuit 612. The pump 632 supplies the brake fluid to a fluid path connecting the second differential pressure control valve 622 and the wheel cylinder 11. A check valve is arranged in series between the pump 632 and the fluid path. The check valve allows the brake fluid to flow in a direction in which the brake fluid is discharged from the pump 632. On the other hand, the check valve restricts the brake fluid from flowing in a direction in which the brake fluid discharged from the pump 632 returns to the pump 632.

In the hydraulic circuit 611, the same number of paths 65a and 65b as the wheel cylinders 11 connected to the hydraulic circuit 611 are provided closer to the wheel cylinder 11 than the first differential pressure control valve 621. Similarly, in the hydraulic circuit 612, the same number of paths 65c and 65d as the wheel cylinders 11 connected to the hydraulic circuit 612 are provided closer to the wheel cylinder 11 than the second differential pressure control valve 622. Each of the plurality of paths 65a to 65d is provided with a holding valve 66 that is closed when restricting an increase in the hydraulic pressure in the wheel cylinder 11 and a pressure reducing valve 67 that is opened when reducing the hydraulic pressure. That is, the holding valve 66 is disposed in a fluid path closer to the wheel cylinder 11 than the differential pressure control valves 621 and 622. The plurality of holding valves 66 are normally open electromagnetic valves, and the plurality of pressure reducing valves 67 are normally closed electromagnetic valves.

A check valve is provided in parallel with the holding valve 66 in each of the plurality of paths 65a to 65d. The check valve allows the brake fluid to flow through the check valve in a direction from the wheel cylinder 11 toward the differential pressure control valves 621 and 622. On the other hand, the check valve restricts the flow of the brake fluid passing through the check valve in a direction from the differential pressure control valves 621 and 622 to the wheel cylinder 11.

The plurality of hydraulic circuits 611 and 612 are connected to reservoirs 681 and 682 that temporarily stores the brake fluid flowing out from the wheel cylinder 11 via the pressure reducing valve 67 when the pressure reducing valve 67 is open. The plurality of reservoirs 681 and 682 are connected to the pumps 631 and 632 via intake flow paths 691 and 692.

The reservoir 681 is connected, via a tank-side flow path 701, to a fluid path connecting the first differential pressure control valve 621 and the master chamber Rm. The reservoir 682 is connected, via a tank-side flow path 702, to a fluid path connecting a connection point with the sixth flow path 58 and the second differential pressure control valve 622 in the second hydraulic circuit 612.

The plurality of pumps 631 and 632 can pump out the brake fluid in the reservoir tank 24 via the reservoirs 681 and 682. The plurality of pumps 631 and 632 discharge the pumped brake fluid to fluid paths between the differential pressure control valve 621 and 622 and the holding valves 66. Fluid paths between the fluid paths and the pumps 631 and 632 are referred to as “intermediate fluid paths 711 and 712”.

### Detection System of Braking Device

As shown in FIG. 1, a detection system of the braking device 20 includes a plurality of sensors. Detection signals from the sensors are input to the control device 100 of the braking device 20. FIG. 1 shows, as the plurality of sensors, a master hydraulic pressure sensor 351, an input hydraulic pressure sensor 352, a control pressure sensor 353, a stroke sensor SE1, a rotation angle sensor SE2, and a current sensor SE3.

The master hydraulic pressure sensor 351 detects the hydraulic pressure in the master chamber Rm. For example, the master hydraulic pressure sensor 351 is provided in the first flow path 331. The hydraulic pressure in the master chamber Rm based on a detection value of the master hydraulic pressure sensor 351 is referred to as a “master pressure”.

The input hydraulic pressure sensor 352 detects the hydraulic pressure in the second fluid chamber R2. For example, the input hydraulic pressure sensor 352 is connected to a position between the first control valve 341 and the second fluid chamber R2 in the second flow path 332. The hydraulic pressure in the second fluid chamber R2 based on a detection value of the input hydraulic pressure sensor 352 is referred to as an “input hydraulic pressure”.

The control pressure sensor 353 is a pressure sensor that detects a hydraulic pressure of the brake fluid supplied from the electric cylinder 51. For example, the control pressure sensor 353 is provided near the output port 516 of the electric cylinder 51. As an example, FIG. 1 shows a configuration in which the control pressure sensor 353 is connected between the release valve 57 and the output port 516 in the release flow path 56. A discharge hydraulic pressure of the electric cylinder 51 based on a detection value of the control pressure sensor 353 is referred to as a “pressure P”.

The stroke sensor SE1 detects the operation amount of the braking operation member 21.

The rotation angle sensor SE2 detects a rotation angle of the first electric motor 513 that is a power source of the electric cylinder 51. The rotation angle of the first electric motor 513 based on a detection value of the rotation angle sensor SE2 is referred to as a “rotation angle θ”. The position of the piston 512 can be estimated based on the rotation angle θ. A rotation speed S of the first electric motor 513 can be calculated based on the rotation angle θ.

The current sensor SE3 can detect a current value of a current flowing through the first electric motor 513. The current value of the first electric motor 513 based on a detection value of the current sensor SE3 is referred to as a “current value T”.

### Control Device of Braking Device

The control device 100 can control the various electromagnetic valves 341, 342, 551, 57 and the first electric motor 513 included in the hydraulic pressure generation device 22 and the various electromagnetic valves 621, 622, 66, 67 and the second electric motor 64 included in the second braking unit 23.

The control device 100 can execute a piston position setting process. The piston position setting process is a process of setting a relative position of the piston 512 with respect to the input port 515 in relation to the control of the electric cylinder 51.

The piston position setting process includes an end-point movement process of moving the piston 512 to the end-point position EP and an origin movement process of moving the piston 512 from the end-point position EP in the forward direction Za by the movement amount Xm. The origin movement process can be executed after the piston 512 moves to the end-point position EP by the end-point movement process.

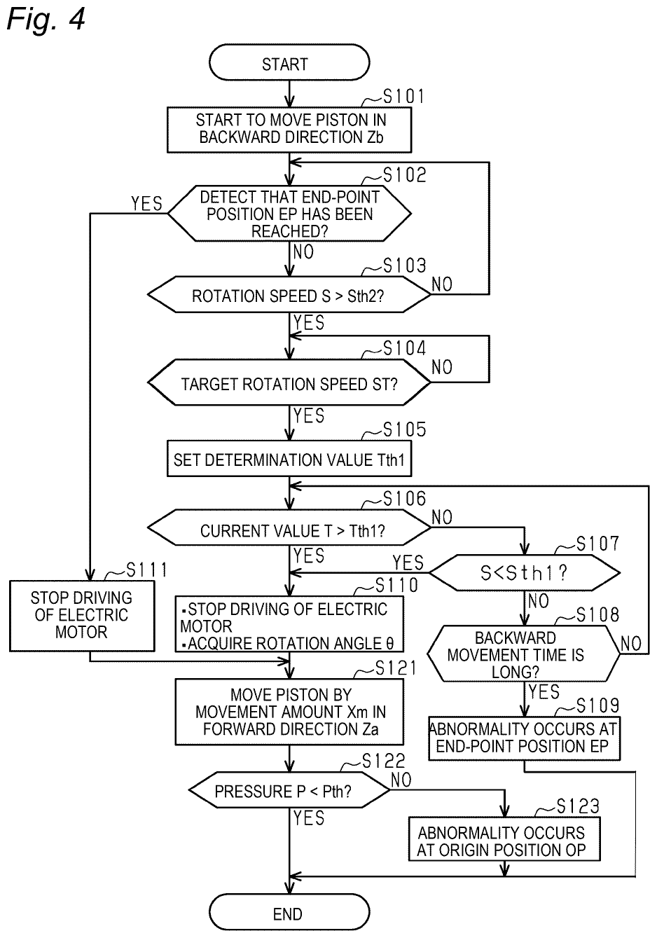

The piston position setting process will be described with reference to FIG. 4. FIG. 4 shows a flow of a process executed by the control device 100. For example, the control device 100 can execute a present processing routine when activating the braking device 20. The braking device 20 is activated, for example, when a start switch of the vehicle is turned on from off.

When the present processing routine is started, first, in step S101, the control device 100 starts driving the first electric motor 513 to move the piston 512 in the backward direction Zb. At this time, the control device 100 performs feedback control such that the rotation speed S of the first electric motor 513 follows a target rotation speed ST. The target rotation speed ST is, for example, a constant value set in advance. When the driving of the first electric motor 513 is started, the control device 100 shifts the process to step S102.

In step S102, the control device 100 determines whether the piston 512 reaches the end-point position EP. Here, for example, when the current value T is larger than a second determination value Tth2 and the rotation speed S is smaller than a first threshold value Sth1, the control device 100 detects that the piston 512 reaches the end-point position EP.

The first threshold value Sth1 is set as a threshold value for determining whether the rotation of the first electric motor 513 is stopped. For example, when the rotation speed S that is equal to or larger than the first threshold value Sth1 becomes smaller than the first threshold value Sth1, it can be determined that the rotation of the first electric motor 513 has stopped.

The second determination value Tth2 can be set as, for example, a value larger than an inrush current at the start of driving the first electric motor 513.

When the rotation of the first electric motor 513 is stopped and the current value T larger than the inrush current is detected, the control device 100 determines that the piston 512 reaches the end-point position EP.

In the process of step S102, when it is detected that the piston 512 reaches the end-point position EP (S102: YES), the control device 100 shifts the process to step S111.

In step S111, the control device 100 temporarily stops driving the first electric motor 513. At this time, the control device 100 may acquire, as an end-point rotation angle θep, the rotation angle θ at a time when the driving of the first electric motor 513 is stopped. The end-point rotation angle θep corresponds to the rotation angle θ at a time when the piston 512 moves to the end-point position EP. When the driving of the first electric motor 513 is stopped, the control device 100 shifts the process to step S121.

On the other hand, when it is not detected that the piston 512 has reached the end-point position EP (S102: NO), the control device 100 shifts the process to step S103. In step S103, the control device 100 determines whether the rotation speed S is larger than a second threshold value Sth2.

The second threshold value Sth2 is set as a threshold value for determining whether the first electric motor 513 starts to operate. The second threshold value Sth2 is a value larger than the first threshold value Sth1. For example, when the rotation speed S that is equal to or smaller than the second threshold value Sth2 becomes larger than the second threshold value Sth2, it can be determined that the first electric motor 513 starts to operate. Here, the start of operation of the first electric motor 513 means that the piston 512 starts to move in the backward direction Zb.

When the rotation speed S is equal to or smaller than the second threshold value Sth2 (S103: NO), the control device 100 shifts the process to step S102 again. On the other hand, when the rotation speed S is larger than the second threshold value Sth2 (S103: YES), the control device 100 shifts the process to step S104.

In step S102 and step S103, the process of step S102 is repeatedly executed until the rotation speed S becomes larger than the second threshold value Sth2 by the process of step S103, that is, until the first electric motor 513 starts to operate.

Furthermore, before the first electric motor 513 starts to operate, when at least one of a condition that the rotation speed S is equal to or larger than the first threshold value Sth1 and a condition that the current value T is equal to or smaller than the second determination value Tth2 is satisfied, the following process is executed. When a negative determination is made in step S102 and a negative determination is made in step S103, the process of step S102 is repeatedly executed. On the other hand, when the current value T is larger than the second determination value Tth2 and the rotation speed S is smaller than the first threshold value Sth1 before the first electric motor 513 starts to operate, it is determined that the piston 512 has already reached the end-point position EP, and the process proceeds to step S111. As a result, the driving of the first electric motor 513 is temporarily stopped.

Here, “when at least one of the conditions is satisfied” means the following. The rotation speed S is larger than or equal to the first threshold value Sth1, and the current value T is larger than the second determination value Tth2. Alternatively, the rotation speed S is smaller than the first threshold value Sth1, and the current value T is equal to or smaller than the second determination value Tth2. Alternatively, the rotation speed S is equal to or larger than the first threshold value Sth1, and the current value T is equal to or smaller than the second determination value Tth2.

In step S104, the control device 100 determines whether the rotation speed S reaches the target rotation speed ST.

When the rotation speed S has not reached the target rotation speed ST (S104: NO), the control device 100 shifts the process to step S104. That is, the control device 100 repeatedly determines whether the rotation speed S reaches the target rotation speed ST until the rotation speed S reaches the target rotation speed ST. During this period, the feedback control of the first electric motor 513 is continued, so that a difference between the rotation speed S and the target rotation speed ST decreases with the lapse of time. The control device 100 can determine whether the rotation speed S reaches the target rotation speed ST, for example, based on the rotation speed S and the target rotation speed ST. The determination of whether the rotation speed S reaches the target rotation speed ST can also be performed based on a duration during which a state where the rotation speed S is larger than the second threshold value Sth2 continues. For example, when a duration during which the rotation speed S is larger than the second threshold value Sth2 is longer than a rotation speed determination time calculated in advance by an experiment or the like, it may be determined that the rotation speed S reaches the target rotation speed ST.

When the rotation speed S reaches the target rotation speed ST, that is, when the first electric motor 513 is rotating so that the rotation speed S follows the target rotation speed ST (S104: YES), the control device 100 shifts the process to step S105. In step S105, the control device 100 sets a first determination value Tth1. The control device 100 sets the first determination value Tth1 based on the current value T flowing through the first electric motor 513 when the rotation speed S follows the target rotation speed ST after the first electric motor 513 starts to operate.

The first determination value Tth1 will be described in more detail.

The first determination value Tth1 is a value set for determining that the piston 512 moves to the end-point position EP. The control device 100 sets the first determination value Tth1 with reference to the current value T when the rotation speed S of the first electric motor 513 follows the target rotation speed ST. The first determination value Tth1 is set to a value smaller than the second determination value Tth2.

For example, the first determination value Tth1 can be calculated as a value obtained by increasing, by an increase amount d, the current value T when the rotation speed S follows the target rotation speed ST. The increase amount d is a predetermined amount set based on the elasticity of the elastic body 518. In the electric cylinder 51 including the elastic body 518, the piston 512 that has moved to a position in contact with the elastic body 518 moves in the backward direction Zb while the elastic body 518 is elastically deformed, and thus the current value T gradually increases. The first determination value Tth1 is a value corresponding to the current value T when the piston 512 moves to the end-point position EP while the elastic body 518 is elastically deformed. For example, the increase amount d can be set to a larger value as the elastic body 518 is less likely to be elastically deformed.

When the first determination value Tth1 is set, the control device 100 shifts the process to step S106.

In step S106, the control device 100 determines whether the current value T is larger than the first determination value Tth1. When the current value T is larger than the first determination value Tth1 (S106: YES), the control device 100 shifts the process to step S110. On the other hand, when the current value T is equal to or smaller than the first determination value Tth1 (S106: NO), the control device 100 shifts the process to step S107.

In step S107, the control device 100 determines whether the rotation speed S is smaller than the first threshold value Sth1. When the rotation speed S is smaller than the first threshold value Sth1, that is, when the rotation of the first electric motor 513 is stopped (S107: YES), the control device 100 shifts the process to step S110. For example, when the rotation of the first electric motor 513 is stopped before it is detected that the current value T becomes larger than the first determination value Tth1, an affirmative determination is made in the process of step S107, and the process proceeds to step S110. On the other hand, when the rotation speed S is equal to or larger than the first threshold value Sth1, that is, when the rotation of the first electric motor 513 is not stopped (S107: NO), the control device 100 shifts the process to step S108.

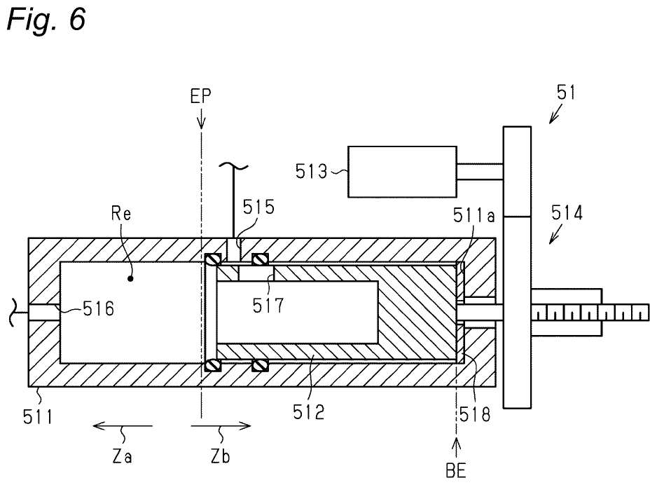

In step S108, the control device 100 determines whether a time in which the first electric motor 513 is driven to move the piston 512 in the backward direction Zb, that is, a backward movement time is longer than the determination time. A determination time is a value calculated in advance by an experiment or the like. The determination time can be set as, for example, a time required to move the piston 512 from an end in the forward direction Za to an end BE in the backward direction Zb when the first electric motor 513 is driven at the target rotation speed ST. That is, a time in which the first electric motor 513 is driven being longer than the determination time means that an abnormality occurs. A state where the piston moves to the end BE in the backward direction Zb is a state where the piston 512 cannot be moved backward any further even if a maximum driving force is generated when the piston 512 moves in the backward direction Zb. Alternatively, the state where the piston moves to the end BE in the backward direction Zb is a state where the piston 512 cannot be mechanically moved backward any more when the piston 512 moves in the backward direction Zb. An example will be described with reference to FIG. 6.

FIG. 6 shows the electric cylinder 51 in a state where the piston 512 moves in the backward direction Zb from the end-point position EP and the piston 512 comes into contact with the rear inner wall 511a of the cylinder 511 with the elastic body 518 interposed therebetween. Since a disc spring as the elastic body 518 at this time is deformed to a limit, the disc spring has a flat plate shape. For example, as shown in FIG. 6, in a state where the piston 512 comes into contact with the rear inner wall 511a via the elastic body 518, the end surface of the piston 512 in the backward direction Zb moves to the end BE in the backward direction Zb. In a configuration in which no elastic body is provided, a state where an end surface of the piston in the backward direction is in contact with a rear inner wall corresponds to a state where the piston moves to an end in the backward direction.

Returning to FIG. 4, when the backward movement time is longer than the determination time in step S108 (S108: YES), the control device 100 shifts the process to step S109. In step S109, the control device 100 determines that an abnormality occurs in the detection of the end-point position EP. For example, the control device 100 may store the occurrence of the abnormality as a history in a storage medium such as a memory. Thereafter, the control device 100 ends the present processing routine. On the other hand, when the backward movement time is equal to or shorter than the determination time (S108: NO), the control device 100 shifts the process to step S106 again.

The processes of steps S106, S107, and S108 can be summarized as follows. That is, when either the condition that the current value T is larger than the first determination value Tth1 or the condition that the rotation speed S is smaller than the first threshold value Sth1 is satisfied while the backward movement time is equal to or shorter than the determination time, the process of step S110 is executed. When neither the current value T is larger than the first determination value Tth1 nor the rotation speed S is less than the first threshold value Sth1 while the backward movement time is equal to or less than the determination time, the driving of the first electric motor 513 is continued.

In step S110, the control device 100 temporarily stops driving the first electric motor 513. That is, when the current value T becomes larger than the first determination value Tth1, the control device 100 determines that the piston 512 reaches the end-point position EP and ends the driving of the first electric motor 513. Alternatively, when the rotation speed S becomes smaller than the first threshold value Sth1, the control device 100 determines that the piston 512 reaches the end-point position EP and ends the driving of the first electric motor 513.

Further, in step S110, the control device 100 acquires, as the end-point rotation angle θep, the rotation angle θ at a time when the piston 512 reaches the end-point position EP. For example, the control device 100 acquires, as the end-point rotation angle θep, the rotation angle θ at a time when the current value T becomes larger than the first determination value Tth1. For example, the control device 100 acquires, as the end-point rotation angle θep, the rotation angle θ at a time when the rotation speed S becomes smaller than the first threshold value Sth1. After executing the process of step S110, the control device 100 shifts the process to step S121.

In step S121, the control device 100 starts driving the first electric motor 513 to move the piston 512 in the forward direction Za. When the piston 512 moves in the forward direction Za by the specified movement amount Xm, the control device 100 ends the driving of the first electric motor 513. The movement amount Xm is a value calculated in advance by an experiment or the like as a movement amount of the piston 512 from the end-point position EP to the origin position OP.

The control device 100 drives the first electric motor 513 to move the piston 512 in the forward direction Za based on the end-point rotation angle θep and a rotation angle for moving the piston 512 by the movement amount Xm in the forward direction Za.

In other words, the control device 100 moves the piston 512 from a position of the piston 512 corresponding to the end-point rotation angle θep as a base point to a position away from the base point by the movement amount Xm in the forward direction Za. Therefore, an amount by which the piston 512 actually moves in the forward direction Za from a time when the driving of the first electric motor 513 is started to move the piston 512 in the forward direction Za is not necessarily equal to the movement amount Xm.

The control device 100 may execute the process of step S121 following the process of step S111. In this case, the control device 100 may drive the first electric motor 513 to move the piston 512 by the movement amount Xm in the forward direction Za from a time when the driving of the first electric motor 513 is started to move the piston 512 in the forward direction Za.

When the piston 512 moves in the forward direction Za in the process of step S121, the control device 100 shifts the process to step S122.

In step S122, the control device 100 determines whether the pressure P is smaller than a closure determination value Pth.

The closure determination value Pth is set to a value calculated in advance by an experiment or the like as a value indicating that the input port 515 is closed by the piston 512 when the pressure P is equal to or larger than the closure determination value Pth. Therefore, the pressure P being smaller than the closure determination value Pth indicates that the input port 515 is not closed by the piston 512. That is, the piston 512 is located in the backward direction Zb with respect to a position where the input port 515 is closed by the piston 512.

When the pressure P is smaller than the closure determination value Pth (S122: YES), the control device 100 ends the present processing routine. The control device 100 acquires the position of the piston 512 at this time as the origin position OP. For example, the control device 100 updates the origin position OP stored in a storage medium such as a memory to the newly acquired origin position OP. For example, the origin position OP can be acquired as the rotation angle θ of the first electric motor 513.

On the other hand, when the pressure P is equal to or larger than the closure determination value Pth (S122: NO), the control device 100 shifts the process to step S123. When the pressure P is equal to or larger than the closure determination value Pth, it can be estimated that the piston 512 moves excessively in the forward direction Za.

In step S123, the control device 100 determines that an abnormality occurs in the detection of the origin position OP. For example, the control device 100 may store the occurrence of the abnormality as a history in a storage medium such as a memory. Thereafter, the control device 100 ends the present processing routine.

In the flow of the process shown in FIG. 4 described above, the processes from steps S101 to S111 correspond to the end-point movement process. The processes of steps S121 to S123 correspond to the origin movement process.

The end-point rotation angle θep acquired in the process of step S110 may be deleted when the piston position setting process is ended, or may be stored as the rotation angle θ corresponding to the end-point position EP and held after the piston position setting process is ended.

### Operations and Effects

An operation and effect of the present embodiment will be described.

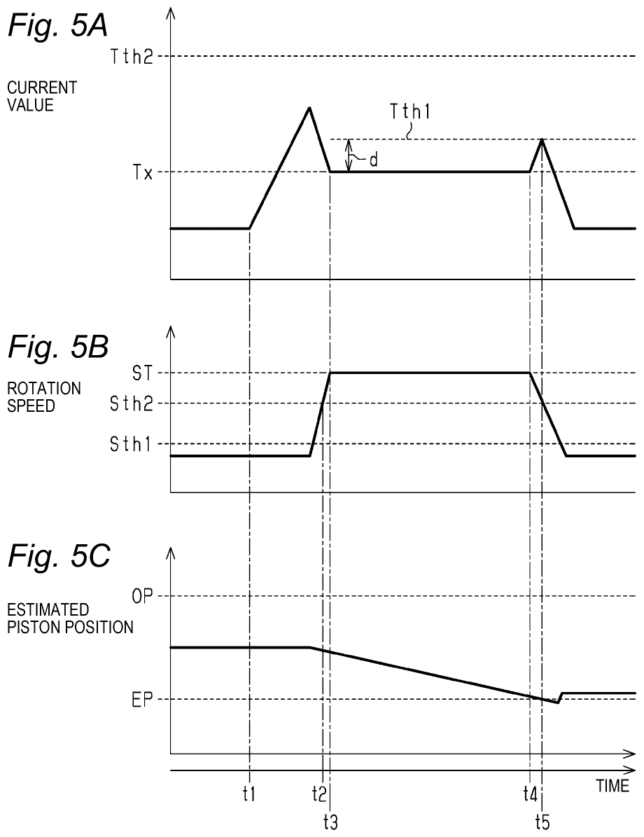

An example when the control device 100 performs the piston position setting process in the electric cylinder device will be described with reference to FIGS. 5A to 5C.

In the example shown in FIGS. 5A to 5C, the piston position setting process is started from a timing t1. In other words, the end-point movement process is started from the timing t1.

As shown in FIG. 5A, the current value T starts to increase at the timing t1. After the timing t1, an inrush current is temporarily generated. FIG. 5A shows the second determination value Tth2.

As shown in FIG. 5B, the rotation speed S starts to increase from the timing t1 to a timing t2. At the timing t2, the rotation speed S increases to the second threshold value Sth2. FIG. 5B shows the first threshold value Sth1, which is a value smaller than the second threshold value Sth2.

Thereafter, at a timing t3, as shown in FIG. 5B, the rotation speed S reaches the target rotation speed ST. Accordingly, the process of setting the first determination value Tth1 is performed (S105). After the timing t3, as shown in FIG. 5A, the current value T transitions to a constant value after a period has elapsed during which the inrush current occurs. In FIGS. 5A to 5C, the current value T at this time is indicated as a reference current value Tx. The control device 100 sets, as the first determination value Tth1, a value obtained by increasing, by the increase amount d, the reference current value Tx.

After the timing t3, the rotation speed S follows the target rotation speed ST. Therefore, the estimated position of the piston 512 transitions to approach the end-point position EP at a constant speed as shown in FIG. 5C.

At a timing t4, as shown in FIG. 5A, the current value T starts to increase from the reference current value Tx. At this time, as shown in FIG. 5B, the rotation speed S starts to decrease. This is because the piston 512 comes into contact with the elastic body 518 at the timing t4. As the elastic body 518 is elastically deformed, the current value T increases, and the rotation speed S decreases.

At a timing t5, as shown in FIG. 5A, the current value T becomes larger than the first determination value Tth1. Therefore, the driving of the first electric motor 513 is stopped (S110). Further, the control device 100 acquires the rotation angle θ at this time as the end-point rotation angle θep.

Here, if it is attempted to move the piston to come into contact with the end in the backward direction, the current value may become excessively large due to an increase in a load applied to the electric motor. In such a case, not only the load of the electric motor increases, but also an excessive load may be applied to components other than the electric motor among the components constituting the electric cylinder as the piston comes into contact with the electric motor.

In this regard, according to the electric cylinder device Of the present embodiment, since the first determination value Tth1 is set to the value obtained by increasing, by the increase amount d, the reference current value Tx, it can be determined that the electric cylinder device has reached the end-point position EP before the current value T becomes excessively large. In other words, the current value T is unlikely to become excessively large until the piston 512 finishes: moving in the backward direction Zb. Therefore, the driving of the first electric motor 513 can be stopped before the current value T becomes excessively large. Accordingly, an excessive load applied to the electric cylinder 51 can be reduced.

In the electric cylinder device according to the present embodiment, since the elastic body 518 is included, a change rate of the current value T while the elastic body 518 is elastically deformed by the movement of the piston 512 in the backward direction Zb is relatively small. For example, the change rate is gentler than that in a case where a piston comes into contact with an end in the backward direction in an electric cylinder device that does not include an elastic body. Therefore, when the end-point position EP is detected, it is possible to prevent the current value T from rapidly increasing. Accordingly, the current value T can be prevented from becoming excessively large. According to the electric cylinder device of the present embodiment, the end-point position EP can be detected in a state where the elastic body 518 is elastically deformed. As described above, in the electric cylinder device of the present embodiment, the end-point position EP can be detected without bringing the piston 512 into contact with the end BE in the backward direction Zb.

After the timing t5 shown in FIGS. 5A to 5C, that is, after the end-point movement process is ended, the origin movement process can be executed. As a result of executing the origin movement process, the piston 512 moves to a position away from a position corresponding to the end-point rotation angle θep by the movement amount Xm in the forward direction Za. Accordingly, the control device 100 can set the origin position OP based on the end-point rotation angle Cep and the movement amount Xm.

When the driving of the first electric motor 513 is ended at the timing t5, the piston 512 also stops moving in the backward direction Zb. In the example shown in FIG. 5C, the position of the piston 512 after the timing t5 is moved from a position of the piston 512 at the timing t5.

As described above, even after it is determined that the piston 512 reaches the end-point position EP and the driving of the first electric motor 513 is temporarily ended, the piston 512 may move regardless of the driving of the first electric motor 513. For example, the piston 512 may move in the backward direction Zb due to a response delay after the first electric motor 513 is stopped. For example, the piston 512 may move when the piston 512 is pressed in the forward direction Za by the elastic body 518. When the piston 512 further moves after the piston 512 ends the movement by the end-point movement process, an error may occur when the origin position OP is set.

In this regard, the electric cylinder device according to the present embodiment is configured to drive the first electric motor 513 based on the end-point rotation angle θep when the piston 512 moves in the forward direction Za by acquiring, as the end-point rotation angle θep, the rotation angle θ when the piston 512 reaches the end-point position EP. Therefore, the piston 512 can be accurately moved by the movement amount Xm from a position detected as the end-point position EP. Thus, the origin position OP can be accurately set.

In the electric cylinder 51, a dynamic friction resistance when the piston 512 moves may fluctuate. For example, the dynamic friction resistance may fluctuate due to expansion, contraction, aging, or the like of the components constituting the electric cylinder 51. When the dynamic friction resistance at the time of moving the piston 512 fluctuates, a torque generated by the first electric motor 513 fluctuates according to the dynamic friction resistance. Therefore, for example, the current value T of the current flowing through the first electric motor 513 when the rotation speed S follows the target rotation speed ST fluctuates. In a configuration in which it is detected that the piston 512 reaches the end-point position EP based on a change in the current value T, if the fluctuation in the dynamic friction resistance is not taken into consideration, the fluctuation in the dynamic friction resistance may cause a decrease in the accuracy of determining that the end-point position EP is reached.

In this regard, the electric cylinder device according to the present embodiment sets the first determination value Tth1 using the current value T when the rotation speed S follows the target rotation speed ST as the reference current value Tx. For example, if the current value T when the rotation speed S follows the target rotation speed ST is relatively large, the first determination value Tth1 is also increased. For example, if the current value T when the rotation speed S follows the target rotation speed ST is relatively small, the first determination value Tth1 is also reduced. Therefore, even when the dynamic friction resistance fluctuates as described above, it is possible to secure the accuracy of determining that the end-point position EP is reached. Accordingly, the variation in the estimated end-point position EP can be reduced. Since the end-point position EP can be accurately detected, the origin position OP can be accurately set.

According to the electric cylinder device of the present embodiment, since the origin position OP can be accurately set, responsiveness when the hydraulic pressure is generated by controlling the electric cylinder 51 is improved.

In the electric cylinder device according to the present embodiment, when it is determined that the piston 512 has already reached the end-point position EP before starting to move, the position of the piston 512 at that time can be set as the end-point position EP (S111). Accordingly, it is possible to prevent the first electric motor 513 from being continuously driven even though the piston 512 moves to the end BE in the backward direction Zb.

### Modifications

The present embodiment can be modified and implemented as follows. The present embodiment and the following modifications can be implemented in combination with each other within a technically consistent range.

In the above embodiment, the processing routine is ended after the process of step S109 in FIG. 4 is executed. Alternatively, a process of moving the piston 512 in the forward direction Za may be executed after the process of step S109 is executed. For example, after the process of step S109 is executed, the process may proceed to step S121. In this case, for example, the piston 512 is moved in the forward direction Za by the movement amount Xm from a position of the piston 512 at the time when the affirmative determination is made in the process of step S108.

In the above embodiment, an example is shown in which, as step S102, when the current value T is larger than the second determination value Tth2 and the rotation speed S is smaller than the first threshold value Sth1, it is detected that the piston 512 reaches the end-point position EP. Instead of this, as the process of step S102, it is also possible to determine whether the piston 512 reaches the end-point position EP regardless of the rotation speed S. For example, in step S102, the process may proceed to step S103 when the current value T is equal to or less than the second determination value Tth2, and the process may proceed to step S111 when the current value T is larger than the second determination value Tth2.

In the above-described embodiment, the origin movement process of steps S121 to S123 is executed by shifting the process to step S121 after step S111. Alternatively, the following retry process may be executed after step S111. For example, in the retry process, after the driving of the first electric motor 513 is stopped as the process of step S111, the piston 512 moves in the forward direction Za by a predetermined retry distance. Thereafter, the process returns to step S101, and the piston position setting process is started again. In such a configuration, the process of step S111 and the retry process may be repeatedly executed. For example, when the retry process is executed a predetermined maximum number of times after the piston position setting process is started, it may be determined that an abnormality has occurred, and the retry process may not be executed. When the retry process is not executed, for example, the origin movement process may be executed by shifting the process from step S111 to step S121.

The brake fluid exemplified in the above-described embodiment is an example of the hydraulic fluid. The wheel cylinders 11 for the rear wheels RL and RR in the above embodiment are examples of the supply target of the hydraulic fluid supplied by the electric cylinder 51. The master cylinder 31 is an example of the supply target of the hydraulic fluid supplied by the electric cylinder 51. The brake fluid discharged from the electric cylinder 51 is supplied to the wheel cylinders 11 for the front wheels FL and FR via the master cylinder 31. Therefore, the wheel cylinders 11 for the front wheels FL and FR are also examples of the supply target of the hydraulic fluid supplied by the electric cylinder 51.

When an elastic body is plastically deformed by, for example, application of an excessive load or excessive repetition of a load in relation to the elastic body, a phenomenon in which the elasticity changes, that is, so-called settling may occur.

If settling occurs in the elastic body 518, a force with which the piston 512 moved to an end of the cylinder 511 in the backward direction Zb is pressed in the forward direction Za by the elastic body 518 is reduced. In such a case, when the piston 512 moves to the end-point position EP, the piston 512 may come into contact with the rear inner wall 511a of the cylinder 511 with the elastic body 518 interposed therebetween as shown in FIG. 6. Therefore, it is preferable to set the increase amount d so that it is determined that the piston 512 has moved to the end-point position EP before the piston 512 comes into contact with the rear inner wall 511a of the cylinder 511 with the elastic body 518 interposed therebetween even if the elastic body 518 has a sag. That is, the increase amount d may be a value set in consideration of the tendency of the elastic body 518 to occur. Further, the increase amount d may be set such that a pressing force by the piston 512 when the first electric motor 513 is driven such that a current value obtained by increasing, by the increase amount d, the reference current value Tx flows is as follows. The increase amount d may be set such that, even when the elastic body 518 is repeatedly deformed a predetermined number of times by being pressed by the piston 512, a pressing force is exerted such that the elastic body 518 is within an allowable range of settling.

The processing circuit such as the control device 100 can be configured as follows. The processing circuit can be implemented as a circuit including one or more processors that execute various processes according to a computer program. The processing circuit can be implemented as a circuit including one or more hardware circuits that execute various processes. The processing circuit can be implemented as a circuit in which one or more processors that execute some of the various processes and one or more hardware circuits that execute the remaining processes of the various processes are combined.

The processor includes a processing device such as a CPU. The processor includes a memory such as a RAM and a ROM. The memory stores a program code or a command configured to cause the processing device to execute a process. The memory, that is, a storage medium includes any available medium that can be accessed by a general-purpose or dedicated computer. Examples of the hardware circuit include an application-specific integrated circuit (ASIC). Another example of the hardware circuit is an FPGA or the like.

1. An electric cylinder device that supplies a hydraulic fluid to a supply target, the electric cylinder device comprising:
a reservoir tank configured to store the hydraulic fluid;
an electric cylinder configured to supply the hydraulic fluid to the supply target by moving a piston in a cylinder according to driving of an electric motor; and
a control device configured to control the electric motor, wherein
the electric cylinder includes a hydraulic chamber defined in the cylinder by the cylinder and the piston, an input port via which the reservoir tank and the hydraulic chamber communicate with each other, and an output port configured to discharge the hydraulic fluid in the hydraulic chamber toward the supply target,
a direction in which a volume of the hydraulic chamber is reduced among moving directions of the piston is defined as a forward direction, and a direction opposite to the forward direction among the moving directions is defined as a backward direction,
the control device drives the electric motor by using, when moving the piston, a position where the piston is moved to an end in the backward direction as an end-point position and an origin position, which is a position obtained by moving the piston from the end-point position in the forward direction by a prescribed movement amount,
the electric cylinder includes an elastic body configured to apply, to the piston, a force to press the piston in the forward direction when the piston is located at the end-point position,
the electric cylinder is configured such that a hydraulic pressure of the hydraulic chamber is increased by opening the input port when the piston is located at the origin position, and closing the input port by the piston when the piston moves in the forward direction from the origin position,
the control device executes an end-point movement process of moving the piston to the end-point position to set a relative position of the piston with respect to the input port,
in the end-point movement process, the control device drives the electric motor such that a rotation speed of the electric motor becomes a target rotation speed to move the piston in the backward direction, and when a current value of a current flowing through the electric motor increases more than a determination value, the control device determines that the piston reaches the end-point position and ends the driving of the electric motor, and
the determination value is a value obtained by increasing, by an increase amount, the current value of the current flowing through the electric motor when the rotation speed of the electric motor follows the target rotation speed with the current value as a reference.

2. The electric cylinder device according to claim 1, wherein
in the end-point movement process, the control device sets the determination value after the electric motor starts to operate.

3. The electric cylinder device according to claim 2, wherein
the determination value is a first determination value,
in the end-point movement process, the control device determines that the piston reaches the end-point position and ends the driving of the electric motor when the current value of the current flowing through the electric motor before the electric motor starts to operate is larger than a second determination value, and
the control device sets the first determination value as a value smaller than the second determination value.
